(19) United States
(12) Patent Application Publication
(10) Pub. No.: US 2005/0184506 A1
(43) Pub. Date: Aug. 25, 2005

(54) Multi-ply form with foldable flaps for non-impact printer

(75) Inventors: Charles A. Campbell, Deerfield Beach, CA (US); Warren M. Fabel, Boca Raton, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Laser Substrates, Inc., Boca Raton, FL (US)

(21) Appl. No.: 11/106,087

(22) Filed: Apr. 14, 2005

Related U.S. Application Data
(63) Continuation-in-part of application No. 10/378,163, filed on Feb. 28, 2003.
(63) Continuation-in-part of application No. 09/102,852, filed on Jun. 23, 1998, now Pat. No. 6,257,624.
(63) Continuation-in-part of application No. 09/097,246, filed on Jun. 12, 1998, now abandoned.
(63) Continuation-in-part of application No. 08/049,946, filed on Apr. 20, 1993, now Pat. No. 5,836,622.
(63) Continuation-in-part of application No. 10/740,071, filed on Dec. 18, 2003.
Application No. 10/740,071 is a continuation-in-part of application No. 10/378,163, filed on Feb. 28, 2003.
Application No. 10/740,071 is a continuation-in-part of application No. 10/255,375, filed on Sep. 26, 2002, now abandoned.
Application No. 10/740,071 is a continuation-in-part of application No. 09/293,496, filed on Apr. 15, 1999, now Pat. No. 6,717,938.
Application No. 10/378,163 is a continuation-in-part of application No. 10/255,375, filed on Sep. 26, 2002, now abandoned.
Application No. 10/378,163 is a continuation-in-part of application No. 09/293,496, filed on Apr. 15, 1999, now Pat. No. 6,717,938.
(60) Provisional application No. 60/361,379, filed on Mar. 1, 2002.

(51) Int. Cl. B42D 15/00

(52) U.S. Cl. 283/98

(57) ABSTRACT

A form assembly is suitable for mailing and includes a front sheet comprising a fold line that separates a first section and a second section of the front sheet. Each section defines a foldable flap along the fold line. Adhesive material is disposed on the back inner face of the front sheet. The form assembly also includes a back sheet comprising at least one die-cut. The die-cut substantially conforms to the second section and a receiving area of the front sheet. Adhesive release material is disposed on the front inner face of the back sheet. Once the die-cut is removed, one of the foldable flaps can be folded along the fold line and adhesively bound to a receiving area of the front sheet that is adjacent to the fold line, thereby resulting in a multi-ply form having a substantially uniform thickness.

### CROSS-REFERENCE TO RELATED APPLICATIONS

The present non-provisional application claims priority to the provisional patent application Ser. No. 60/XXX,XXX with inventors Campbell et al. entitled “MULTI-PLY FORM WITH FOLDABLE FLAPS FOR NON-IMPACT PRINTER” filed Apr. 8, 2005, which is hereby incorporated by reference in its entirety.

The present U.S. patent application is also a continuation-in-part of U.S. patent application Ser. No. 10/378,163, filed Feb. 28, 2003, which was based on U.S. Provisional Patent Application No. 60/361,379 filed Mar. 1, 2002. The aforementioned non-provisional application is also a continuation-in-part of U.S. patent application Ser. No. 09/102,852 filed Jun. 23, 1998, now U.S. Pat. No. 6,257,624 issued Jul. 10, 2001, U.S. patent application Ser. No. 09/097,246 filed Jun. 12, 1998 and U.S. patent application Ser. No. 08/049,946 filed Apr. 20, 1993, now U.S. Pat. No. 5,836,622 issued Nov. 17, 1998, all of which are herein incorporated by reference in their entirety.

Also, this present U.S. Patent application is a continuation-in-part of U.S. patent application Ser. No. 10/740,071, filed Dec. 18, 2003, which is a continuation-in-part of U.S. patent application Ser. No. 10/378,163 filed Feb. 28, 2003. The aforementioned application is also a continuation-in part of U.S. patent application Ser. No. 10/255,375 filed Sep. 26, 2002. Both of the aforementioned non-provisional U.S. Patent Applications are continuation-in-part applications of U.S. patent application Ser. No. 09/293,486 filed Apr. 15, 1999. All of the above-referenced applications are each herein incorporated by reference in their entirety.

### FIELD OF THE INVENTION

The present invention generally relates to forms suitable for mailing and more particularly to forms suitable for mailing where images are formed on two sides of the form using non-impact printers.

### BACKGROUND OF THE INVENTION

In recent years there has been a proliferation of digital photography, subsequently spawning a new generation of low cost, high print quality printers. These printers generally accept standard 4″×6″ photo paper or other types of paper of various sizes and are usually simplex printers. The high print quality of these printers allows users to print professional looking photographs. In addition to printing photographs, many individuals and businesses alike have the need to print mailable form assemblies such as postcards. A postcard can include one or more images printed on a first side and mailing information printed on the opposite side. Individuals, for example, may want to send announcements or invitations to friends, family, etc. Also, business entities such as real estate brokers, yacht brokers, and the like may want to mail photos of offerings quickly to a list of qualified potential buyers.

Being able to use home or office printers for creating the mailable form is advantageous over using a commercial service for creating the mailable forms. For example, commercial services are generally costly, have a slow turn around, and usually require a significant number of postcards to be ordered. Thus, if time is of the essence in sending out an offering, businesses are restricted to the turn around time of the commercial service provider. Also, using a commercial service may become costly for an individual who only wants to send out a few mailings. Although users can now more easily create their own mailable forms, many problems still exist with the currently available forms.

One problem is that the United States Postal Service (USPS) has specific dimension requirements for standard rate postcards. Generally, a width of 3½ ″ to 4¼″ and a length of 5½″ is required for a standard rate postcard. Also, the minimum thickness of a standard rate post card is 0.006″. Thus, finding printable forms that conform to the USPS specifications may be difficult. Therefore, a need exists for forms that allow printing on one side and that can be easily assembled into a standard rate two-faced post card.

Yet another problem is that if the postcard fails to have a uniform thickness, the use of automated mechanical postage sorting machines may damage the postcard. For example, if labels are attached that create non-uniform thickness, the label can be ripped off by the machines. Therefore, a need exists for a mailable form having a uniform thickness.

Furthermore, many of the affordable printers used for printing high quality images are simplex, that is, they do not automatically print on both sides of the paper. Mailable forms having two sides need to be feed back into the printer so that the back side of the form can be printed. Hand feeding a printer takes time and is not efficient when printing a large quantity of forms. Therefore, a need exists for a form that can print all of the required images and information on a single side but be assembled to create a standard rate post card.

### SUMMARY OF THE INVENTION

Briefly, in accordance with the present invention, disclosed is a form assembly having sections for printing an image on one side of the form. In an embodiment of the present invention, the form assembly includes a front sheet having a front outer face and a front inner face. The front outer face includes at least a first ply to define a first side of a multi-ply form, which is suitable for mailing. The front sheet being adapted to accept at least one printable image formed thereon. A fold line is also included on the front sheet and separates a first section and a second section of the front sheet. The resulting area of the first section is greater than a resulting area of the second section and the second section defines a foldable flap along the fold line. An adhesive material being patternly disposed on the back inner face of the front sheet.

The form assembly also includes a back sheet that is formed with at least a second ply resulting in a front inner face and a back outer face. At least one die-cut is formed from the back sheet and substantially defines a portion conforming to the second section of the front sheet and a receiving area of the first section of the front sheet. Adhesive release material is patternly disposes on the front inner face of the back sheet except in a first area. The front inner face of the back sheet is adhesively attached to the back inner face of the front sheet.

When the portion of the back sheet defined by the die-cut is removed and the foldable flap of the front sheet is folded along the fold line, the foldable flap becomes adhesively bound to a receiving area of the front sheet adjacent to the fold line. When folded, the foldable flap substantially abuts a remaining portion of the back sheet that is adhesively attached to the front sheet giving the multi-ply form, as assembled, a substantially uniform thickness.

The features of the present invention are advantageous as all printed images are printed on one face of the form assembly (when the mailer is in an initial unfolded form) and thus it allows the form assembly to be printed in a typical sheet-fed non-impact printer or impact printer.

In another embodiment of the present invention disclosed is a form assembly having a front sheet formed with a front outer face and a back inner face. The front outer face includes at least a first ply to define a first side of a multi-ply form that is suitable for mailing. The front sheet being adapted to accept at least one printable image formed thereon. A fold line is also included on the front sheet that separates a first section and a second section of the front sheet. The resulting area of the first section is equal to a resulting area of the second section. A first foldable flap being defined by the first section and a second foldable flap being defined by the second section. The back inner face of the front sheet includes an adhesive material that is patternly disposed thereon.

The form assembly also includes a back sheet that is formed with at least a second ply resulting in a front inner face and a back outer face. The back sheet substantially conforms to the front sheet. Adhesive release material is patternly disposed on the front inner face of the back sheet, the front inner face being adhesively attached to the back inner face of the front sheet.

When the back sheet is removed and one of the first foldable flap and the second foldable flap of the front sheet can be folded and adhesively bound to the back inner face of the front sheet. The multi-ply form is assembled to have a substantially uniform thickness.

In yet another embodiment of the present invention disclosed is a form assembly having a front sheet formed with a front outer face and a back inner face a front sheet. The front outer face includes at least a first ply to define a first side of a multi-ply form that is suitable for mailing. The front sheet being adapted to accept at lease one printable image formed. A fold line is also included on the front sheet and separates a first section and a second section of the front sheet. The resulting area of the first section is equal to a resulting area of the second section. A first foldable flap is defined by the first section and a second foldable flap is defined by the second section. Adhesive material is patternly disposed on the back inner face of the front sheet.

The form assembly also includes a back sheet formed with at least a second ply that results in a front inner face and a back outer face. The back sheet includes at least one die-cut that substantially defines a portion conforming to the second section of the front sheet. The front inner face of the back sheet having adhesive release material patternly disposed on the portion defined by the die-cut conforming to the second section of the front sheet. The front inner face of the back sheet being adhesively attached to the back inner face of the front sheet.

When the portion of the back sheet defined by the die-cut is removed, one of the first foldable flap and the second foldable flap of the front sheet can be folded and adhesively bound to a remaining portion of the back sheet on the first section. The multi-ply form is assembled to have a substantially uniform thickness.

In another embodiment of the present invention disclosed is a multi-ply form assembly for duplex printing including a sandwich assembly of a top ply and a bottom ply. Each of the top ply and the bottom ply include an outer face for accepting at least one printable image formed thereon in a duplex non-impact printer. A fold line separates the outer face of both the top ply and the outer face of the bottom ply into two substantially equal areas of a first area and a second area. The top ply includes an inner surface of the second area defined by the fold line with adhesive material disposed thereon. The top ply also having an inner surface of the first area defined by the fold line with adhesive release material disposed thereon. The bottom ply includes an inner surface of the first area defined by the fold line with adhesive material disposed thereon. The bottom ply also includes an inner surface of the second area defined by the fold line with adhesive release material disposed thereon.

When the top ply is separated from the bottom ply, each of the top ply and the bottom ply are foldable along the fold line. Folding the top ply along the fold line allows the inner surface of the top play with adhesive material disposed thereon is adhesively bound to the inner surface of the top ply with adhesive release disposed thereon. Folding the bottom ply along the fold line allows the inner surface of the bottom ply with adhesive release material disposed thereon is adhesively bound to the inner surface of the bottom ply with adhesive material disposed thereon.

Another advantage of the present invention is that it results in a mailable form assembly that conforms to the USPS specifications for standard rate postage. Having a uniform thickness helps the form assembly survive the rigors of mail processing by the various postal services including the USPS and other entities.

Another advantage of the present invention is that the form assembly is easily printable by a standard non-impact or impact printer. Printing of the form assembly does not require the adjustment of the printer. This is beneficial to the consumer as it results in a more efficient printing process.

The features of the present invention are advantageous as all the printed images and mailing information is printed on one face of the form assembly (when the mailer is in an initial unfolded folded form) and thus it allows the mailer to be printed in a typical simplex non-impact or impact printer. Additionally, when folded, the form assemble has a uniform thickness and conforms to the USPS specifications for a standard rate post card.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is an isometric view of a first embodiment of the present invention;

FIG. 2 is a side view of the first embodiment in FIG. 1;

FIG. 3 is a side view of the first embodiment in FIG. 1 with a foldable flap partially folded;

FIG. 4 is a side view of the first embodiment in FIG. 1 when completely folded about a fold line;

FIG. 5 is an isometric view of a second embodiment of the present invention;

FIG. 6 is a side view of the second embodiment of the form assembly in FIG. 4;

FIG. 7 is a side view of the second embodiment of the form assembly in FIG. 4 with a foldable flap partially folded;

FIG. 8 is a side view of the second embodiment in FIG. 5 when completely folded about a fold line;

FIG. 9 is a side view of a third embodiment of the present invention;

FIG. 10 is a side view of the third embodiment in FIG. 7 when the top ply is completely folded about a fold line;

FIG. 11 is a side view of the third embodiment in FIG. 7 when the bottom ply is completely folded about a fold line;

FIG. 12 is a top view of the second embodiment in FIG. 5 including printed images;

FIG. 13 is an isometric view of a fourth embodiment of the present invention including a side tab; and

FIG. 14 is a top view of the fourth embodiment in FIG. 13.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts through several views.

### First Embodiment

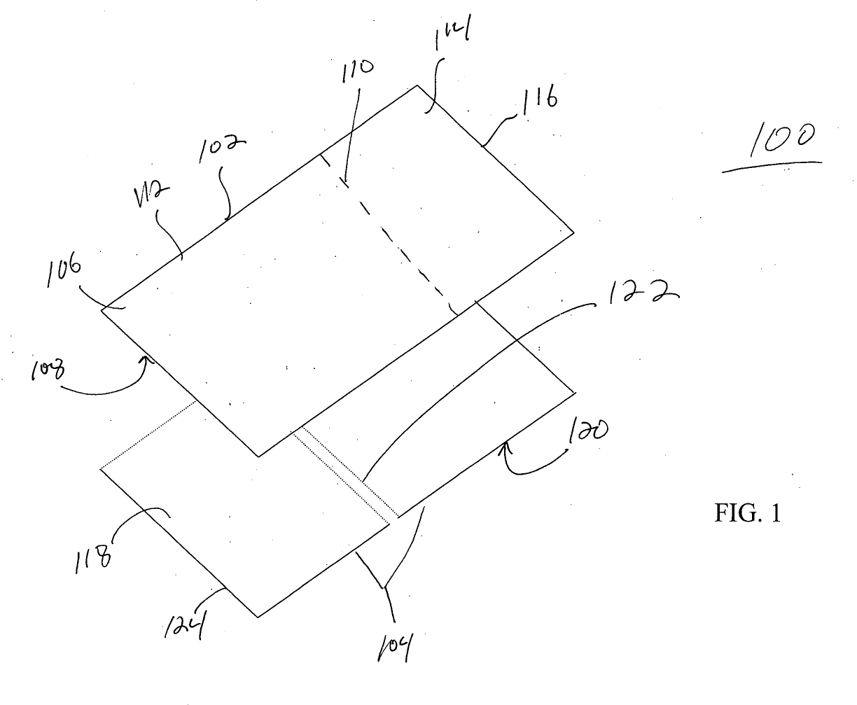

According to an embodiment of the present invention, as shown in FIG. 1, an exemplary form assembly 100 is illustrated. FIG. 1 shows a front sheet 102 and a back sheet 104 that combine to create the multi-ply form assembly 100, for example, a two-ply form that is suitable for mailing.

The front sheet 102 includes a front outer face 106 and a back inner face 108. The front outer face 106 includes at least a first-ply to define a first side of the form assembly 100 and is adapted to accept one or more printable images thereon. For example, the form assembly 100 may be sent through a simplex non-impact or impact printer so that at least one image is printed on the front outer face 106 of the front sheet 102. A simplex non-impact printer includes, for example, both laser and inkjet printers where tractor feed edges are not required. It is also important to note that any type of printer or image forming device can be used with the form assembly, including those printers that form images with lasers, ribbons, organic and inorganic chemicals and dyes, and equivalents. A fold line 110 is situated on the front sheet 102 so that a first section 112 and a second section 114 of the front sheet 102 are defined. In the embodiment shown in FIG. 1, the first section 112 has a resulting area that is greater than the resulting area of the second section 114. Each section 112, 114 may have a separate printable image formed thereon. The second section 114 defines a foldable flap 116 when the second section is folded along the fold line 110. Adhesive material, for example, is patternly disposed over substantially the entire back inner face 108 of the front sheet 102 for bonding front sheet 102 and the back sheet 104 together.

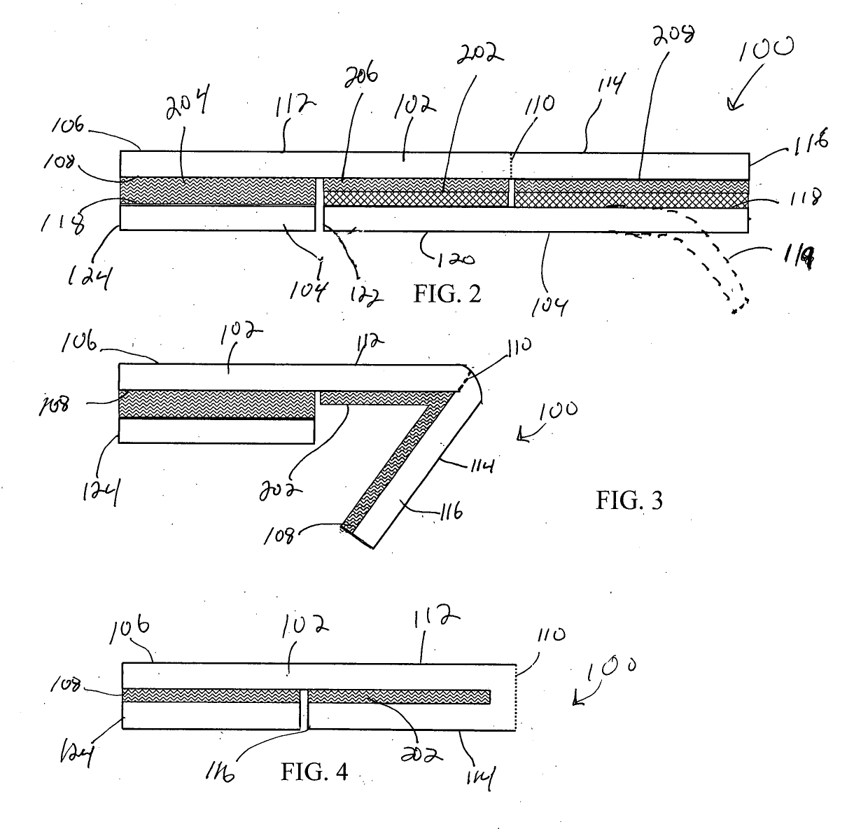

The back sheet 104 includes at least a second-ply and results in a front inner face 118 and a back outer face 120 of the back sheet 104. An area of the back sheet 104 substantially conforms to an area the front sheet 102 so that when the front sheet 102 and the back sheet 104 are adhesively bound to each other in a sandwich configuration, the outer edges of each sheet 102, 104 are substantially co-linear. At least one die-cut 122 formed from the back sheet 104 defines a portion of the back sheet 104 that substantially conforms to the second section 114 and a receiving area 202 of the front sheet 102. The receiving area 202, as shown in FIG. 2, of the front sheet 102, for example, is an area of the back inner face 108 of the front sheet 102 that is equal in area to the second section 114 of the front sheet 102 and is situated adjacent to the fold line 110. Adhesive release material is patternly disposed on the front inner face 118 of the back sheet 104, except on a portion 124 of the back sheet 104 that remains affixed to the front sheet 102 to form a multi-ply form after the die-cut portion 122 of the back sheet 104 is removed. The adhesive release material allows the front inner face 118 of the back sheet 104 to be adhesively attached to the back inner face 108 of the front sheet 102. Instructional information (not shown) such as how to use the form assembly 100 may be optionally included on the back outer face 120 of the back sheet 104.

FIG. 2 illustrates a side view of the form assembly 100 in FIG. 1. The adhesive material on the back inner face 108 of the front sheet 102 discussed is shown as a first area of adhesive 204, a second area of adhesive 206, and a third area of adhesive 208. These areas of adhesive 204, 206, 208 are for illustrative purposes only. In FIG. 1 these areas of adhesive material 204, 206, 208 are combined to form one substantially coherent area of adhesive material. The receiving area 202 of the front sheet 102 is represented in FIG. 2 by the second area of adhesive material 206, which is optional. For example, having adhesive material on the receiving area 202 of the front sheet 102 gives added support to the form assembly 100 when passing through a printing device. The die-cut portion 122 of the back sheet 104 has a layer of adhesive release material patternly disposed on substantially the entire surface so that the die-cut portion 122 of the back sheet 104 can be easily removed from the back inner face 108 of the front sheet 102, as illustrated by the dashed lines 119. The gaps between the various areas of adhesive and adhesive release material are shown for illustrated purposes only. Alternatively, the adhesive material on the receiving area 202 and the adhesive release material on the corresponding area of the front inner face 118 of the back sheet 104 may be alternated so that when the die-cut portion 122 of the back sheet 104 is removed from the back inner face 108 of the front sheet 102, the receiving area 202 of the front sheet 102 is free of any adhesive material.

FIG. 3 and FIG. 4 illustrate a side view of the form assembly 100 in FIG. 1 when the foldable flap 116 is partially folded and completely folded along the fold line 110, respectively. After the die-cut portion 122 of the back sheet 104 is removed from the back inner face 108 of the front sheet 102, the adhesive on the back inner face 108 is exposed. The foldable flap 116 of the front sheet 102 may then be folded along the fold line 110 and adhesively bound to the receiving area 202 of the front sheet 102. It should be noted that first section 112 can also be define a foldable flap so that the first section 112 is folded along the fold line 110 onto the second section 114. After the foldable flap 116 is folded and bound to the receiving area 202, the foldable flap 116 substantially abuts the remaining portion 124 of the back sheet 104 that is adhesively attached to the front sheet 102 thereby creating a multi-ply assembly form having a substantially uniform thickness. Stated differently, the resulting form assembly of FIG. 4 has the same number of ply layers in a stacked or sandwich configuration through out. One advantage of the present invention is that by having a substantially uniform thickness, the assembly form can be processed by mechanical postage sorting machines easier and with less damaged caused from non-uniform thickness.

### Second Embodiment

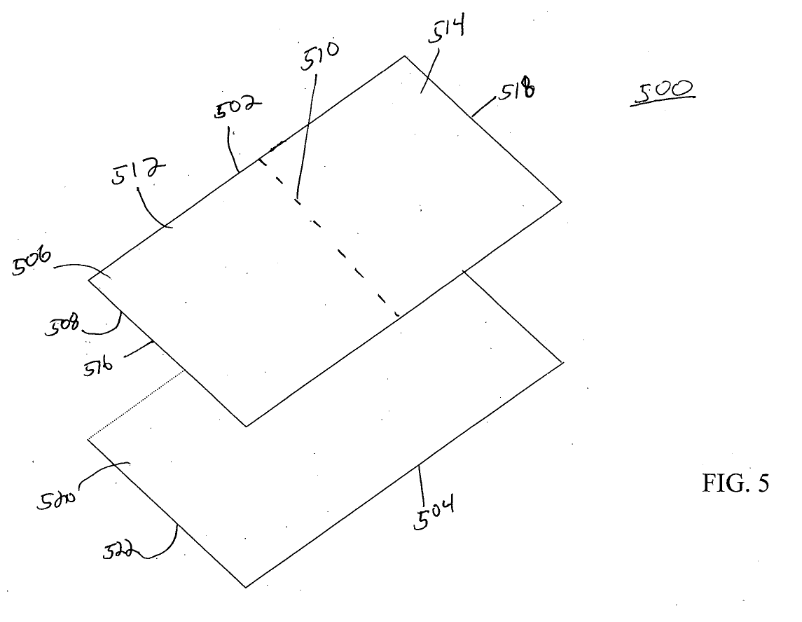

FIG. 5 illustrates a second exemplary embodiment of the present invention. Shown in FIG. 5 is a form assembly 500 having a front sheet 502 and a back sheet 504. In this embodiment, the front sheet 502 and the back sheet 504 combine to create a multi-ply form assembly 500, for example, a two-ply form that is suitable for mailing. It is important to note that other number of plies have been shown to be used advantageously with the present invention.

The front sheet 502 includes a front outer face 506 and a back inner face 508. The front outer face 506 includes at least a first-ply to define a first side of the form assembly 500 and is adapted to accept one or more printable images thereon. For example, the assembly form 500 may be sent through a simplex non-impact or impact printer as described above for the first embodiment so that at least one image is printed on the front outer face 506 of the front sheet 502. A fold line 510 is situated on the front sheet 502 so that a first section 512 and a second section 514 of the front sheet 502 are defined. The first section 512 has an area that is equal to the area of the second section 514. Each section 512, 514 may have one or more separate printable images formed thereon. The first section 512 defines a first foldable flap 516 and the second section 514 defines a second foldable flap 518. Adhesive material, for example, is patternly disposed on substantially the entire back inner face 508 of the front sheet 502. Preferably, the adhesive material stops at the edges of the back inner face 508 and at the fold line 508 so that premature adhesion and bleeding is prevented.

The back sheet 504 includes at least a second-ply and results in a front inner face 520 and a back outer face 522 of the back sheet 504. The back sheet 504 substantially conforms to the front sheet 502 so that when the front sheet 502 and the back sheet 504 are adhesively bound to each other, the outer edges of each sheet 502, 504 are substantially co-linear. Adhesive release material is patternly disposed on substantially the entire front inner face 508 of the back sheet 504 so that the entire back sheet 504 can be removed from the front sheet 502. Instructional information (not shown) such as how to use the form assembly may be optionally included on the back outer face 522 of the back sheet 504.

Once the back sheet 504 is removed, the first foldable flap 516 or the second foldable flap 518 can be folded about the fold line 510 and adhesively bound to the back inner face 508 of the front sheet 502. Because the first section 512 and the second section 514 have equal areas, the foldable flap 516, 518 that is folded along the fold line 510 substantially covers the entire portion of the back inner face 508 adjacent to the fold line 510.

FIG. 6 shows a side view of an alternative embodiment of the form assembly in FIG. 5. The embodiments in FIG. 5 and FIG. 6 are similar except for the back sheet 504. The back sheet 504 of the embodiment illustrated in FIG. 6 includes a die-cut 602 that substantially conforms to the second section 514 of the front sheet 502. Adhesive release material is patternly disposed on the portion of the back sheet 504 defined by the die-cut 602. The portion 604 remaining after the die-cut portion 602 of the back sheet 504 is removed, for example, is permanently bound to the back inner face 508 of the front sheet 502 corresponding to the first section 512. Alternatively, the die-cut 602 can substantially conform to the first section 512 of the front sheet 602 and the remaining portion 604 can alternately correspond to the second section 514 of the front sheet 502. The dashed lines 521 are shown to illustrate how the portion of the back sheet 504 defined by the die-cut 602 can be removed from the back inner face 508 of the front sheet 502.

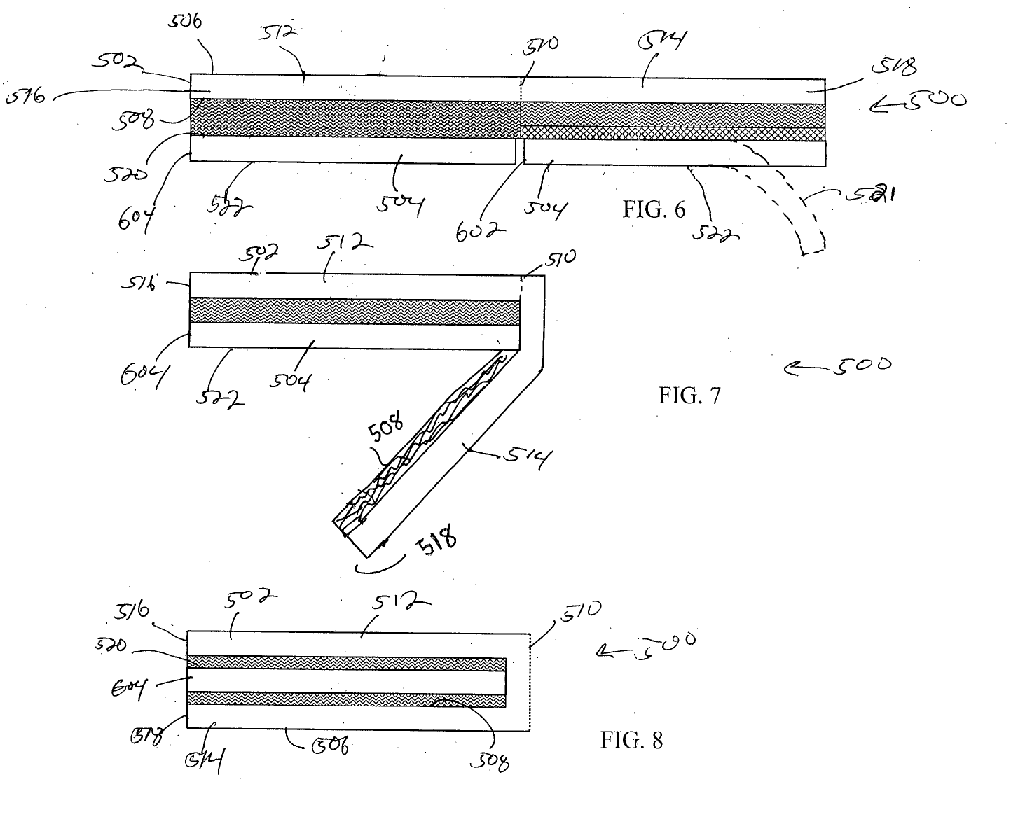

FIG. 7 and FIG. 8 illustrate a side view of the alternative embodiment in FIG. 6 when one of the foldable flaps 516, 518 is partially folded and completely folded along the fold line 510, respectively. The adhesive release material on the die-cut portion 602 allows the portion of the back sheet 504 defined by the die-cut 602 to be removed from the back inner face 508 of the front sheet 502, thereby exposing the adhesive material on the back inner face 508. Once the portion of the back sheet 504 defined by the die-cut 602 is removed, the first foldable flap 516 or the second foldable flap 518 can be folded about the fold line 510, thereby adhesively bonding the remaining portion 604 of the back sheet 504 to the back inner face 508 of the front sheet 502. After the folding process, the outer edges of the first section 512, the second section 514, and the remaining portion 604 of the back sheet 502 are substantially co-linear.

### Third Embodiment

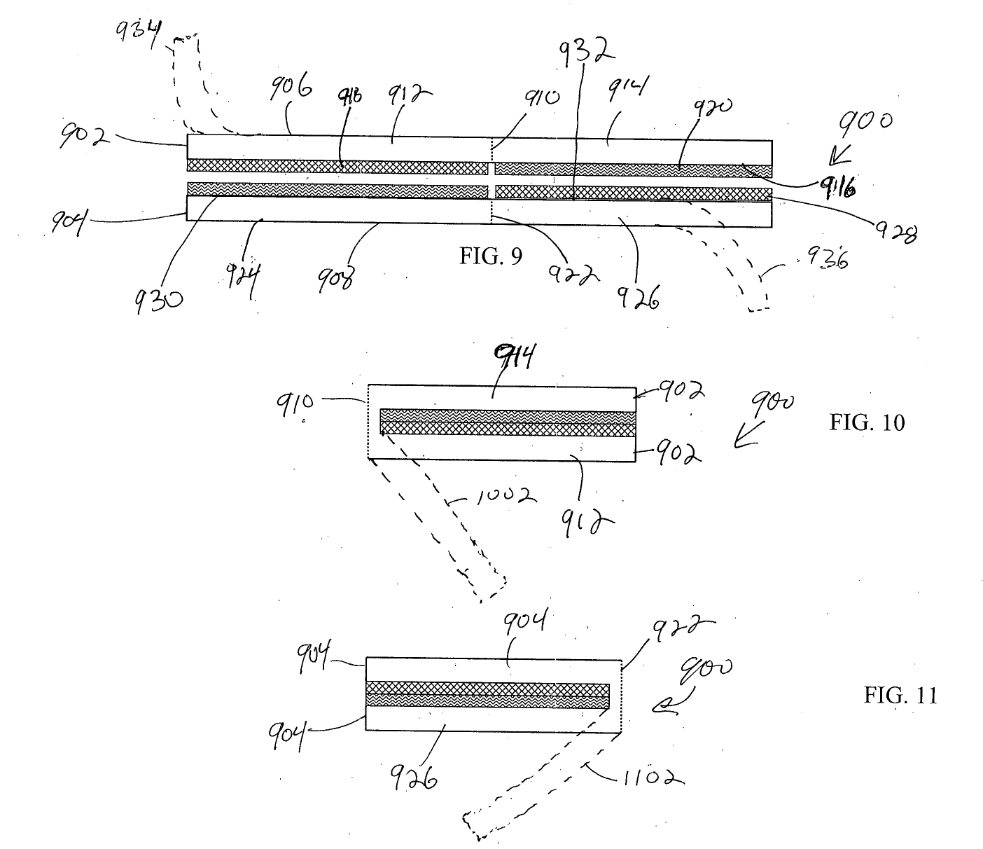

FIG. 9 illustrates a third embodiment of the present invention. FIG. 9 shows a form assembly 900 including a front ply 902 and a back ply 904 in a sandwich configuration. In this embodiment, the front ply 902 includes an outer face 906 and the back ply also includes and outer face 908. Each outer face 906, 908 is adapted for accepting one or more printable image thereon. For example, the form assembly 900 may be passed through a simplex printer for printing an image on the front ply 902 and then passed through the simplex printer again for printing the same or different image on the back ply 904. Alternatively, the form assembly 900 may be passed through a duplex printer for printing images on both the front ply 902 and the back ply 904 of the form assembly 900 without a user having to re-feed the form assembly 900 through the printer.

The top ply 902 includes a foldable line 910 that separates the outer face 906 of the top ply 902 into two substantially equal areas, a first area 912, and a second area 914. The top ply also includes an inner surface 916 with a first portion 918, defined by the first area 912, having adhesive release material disposed thereon and a second portion 920, defined by the second area 714, having adhesive material disposed thereon.

The bottom ply 904 also includes a foldable line 922 that separates the outer face 908 of the bottom ply 904 into two substantially equal areas, a first area 924, and a second area 926. The bottom ply also includes an inner surface 928 with a first portion 930, defined by the first area 924, having adhesive material disposed thereon and a second portion 932, defined by the second area 926, having adhesive release material disposed thereon.

The adhesive and adhesive release materials are disposed on the inner surfaces 916, 928 of the front and bottom plies 902, 904 in an alternative pattern so that when the top ply 902 and the bottom ply 904 are sandwiched together, the adhesive material contacts the adhesive release material, thereby allowing each ply 902, 904 to be separated from the other and used as a separate form assembly, as is illustrated by the dashed lines 934, 936 on the front ply 902 and the back ply 904.

When the top ply 902 and bottom ply 904 are separated from each other, each ply 902, 904 is foldable along its respective fold line 910, 922, as is illustrated by the dashed lines 1002, 1102 in FIG. 10 and FIG. 11. As the front ply, for example, is folded, the inner surface 916 of the front ply 902 having adhesive material disposed thereon comes into contact with and becomes adhesively bound to the inner surface 916 of the front sheet 902 having adhesive release material disposed thereon. Accordingly, a multi-ply form assembly is created, as illustrated in FIG. 10. The same occurs for the bottom ply 904 when folded along its fold line 922, as illustrated in FIG. 11. Alternatively, the user can choose to only use one of the front ply 902 or bottom ply 904 as the form assembly and discard the remaining ply.

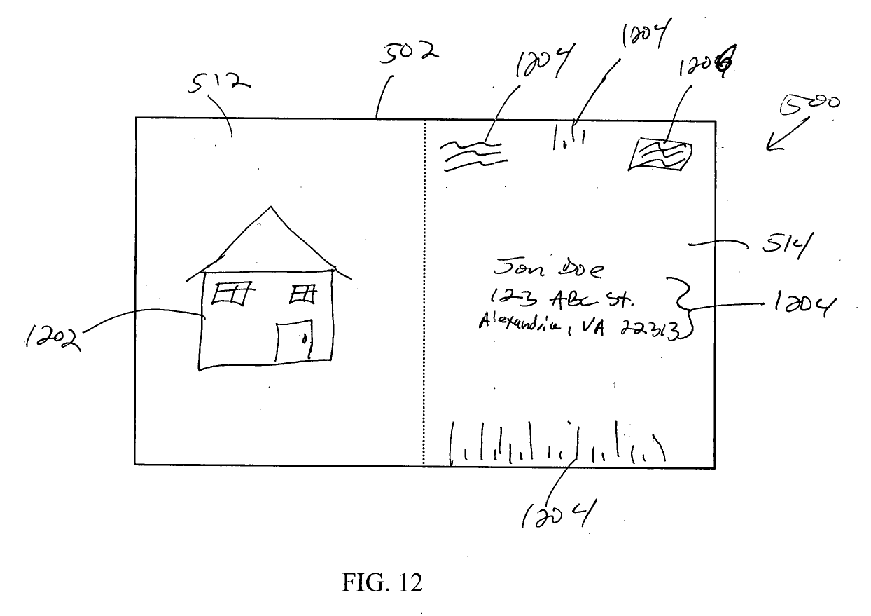

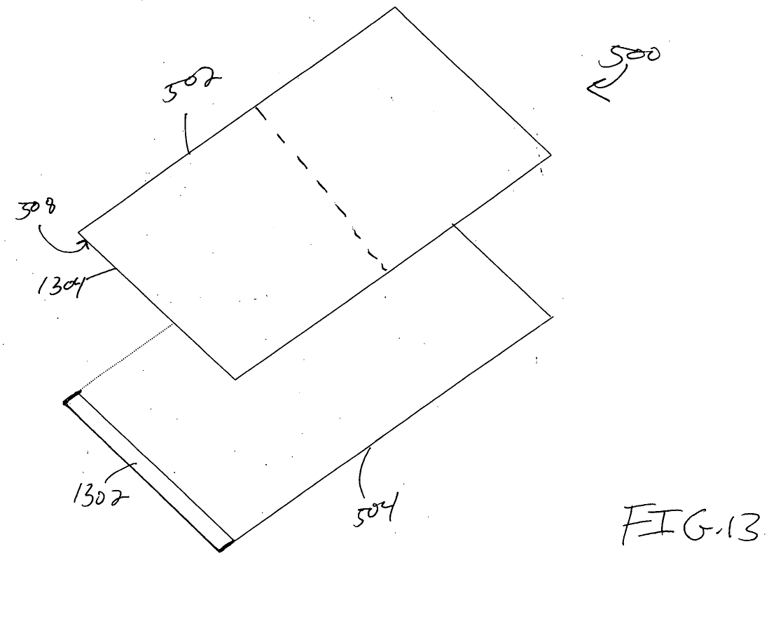

FIG. 12 shows a top view of the embodiment in FIG. 5. However, the following discussion is also applicable to the embodiments according to FIGS. 1-4, and FIGS. 9-11. As discussed above, the front outer face 106, 506 of the embodiments in FIGS. 1-8 and both outer faces 906, 908 of the embodiment in FIGS. 9-12 may have one or more images printed thereon. Using the form assembly in FIG. 5 as an example, the first section 512, and the second section 514 of the front sheet 502 each may have a separate image(s) printed thereon. The types of printed images can be graphics, photographs, text characters, mailing indicia, addressee information, or the like. For example, if a user wants to send a real estate listing to a potential buyer, the user can send the form assembly 500 in FIG. 5 through an inkjet photo printer. The user could also use the form assemblies in FIG. 1, FIG. 6, and FIG. 9 in the same manner. A picture of a house 1202 that is for sell is printed on one of the first or second section 512, 514 of the front sheet 502 and mailing information 1204 including electronic postage 1206 is printed on the section that is opposite from the photograph. Information about the house can also be printed on the same section as the real estate listing. Once the images are printed on the form assembly 500, the user removes the removable portion of the back sheet 504 and folds the form to create the multi-ply form assembly shown in FIG. 8 with mailing indicia and address information on one side and a printed image(s) on the other side.

Another advantage of the present invention is that individuals or businesses can print the mailing information and the images during a single pass of the assembly form through a simplex non-impact printer. The user does not have to flip the form over and send the form through the printer for a second pass. Also, after the form assembly is folded, the resulting dimensions of the multi-ply form conform to the specifications set forth by the United States Postal Service. For example, the length, width, and thickness of the resulting multi-ply form in one or more of the embodiments described can result in a standard rate postcard. Additionally, the assembly forms described above may be adapted for allowing a plurality of post cards to be created from a single sheet of paper. For example, the assembly form can be one of 8.5″×11″ (letter) size paper, 8.5″×14″ (legal) size paper, 8.27″×11.69″ (A4) size paper, 3.94″×5.83″ (postcard) size paper, 4″×6″ (photo) size paper, 3″×5″ (photo) size paper, 4.13″×9.5″ (envelope) size paper, or the like.

### Fourth Embodiment

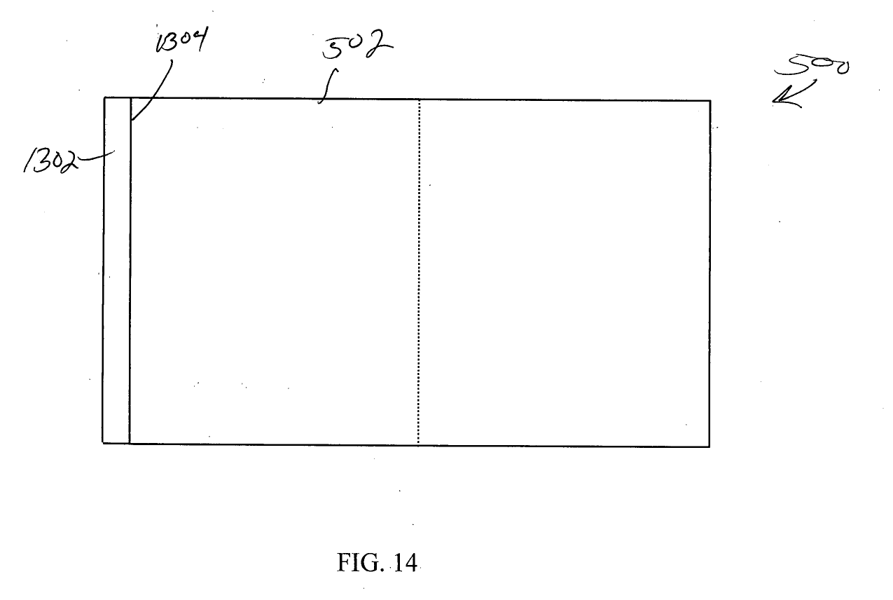

FIG. 13 and FIG. 14 illustrate an isometric and top view, respectively, of a fourth embodiment of the present invention. FIG. 13 and FIG. 14 show, for example, the form assembly 500 of FIG. 5 with a portion 1302 of the back sheet 504 extending beyond an outer edge 1304 of the front sheet 502. The portion or tab 1302 that extends beyond the outer edge 1304, for example, allows the back sheet 504 to be easily removed from the back inner face 508 of the front sheet 502. The tab 1302 also allows a printer to grab on to an area of the form 500 so that an image can be printed all the way to the outer edge 1304 of the front sheet 502. The tab 1302 may also be included on any of the embodiments above and on any of the outer edges of the form assemblies depending on the orientation of the forms.

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

1. A form assembly having sections for printing an image on one side thereon by a non-impact printer, the form comprising:
a front sheet formed with a front outer face and a back inner face,
the front outer face of the front sheet including at least a first ply to define a first side of a multi-ply form suitable for mailing and adapted to accept at least one printable image formed thereon, the front sheet including a fold line separating a first section and a second section of the front sheet, wherein a resulting area of the first section is greater than a resulting area of the second section, and the second section defines a foldable flap along the fold line; and
the back inner face of the front sheet including an adhesive material patternly disposed thereon;
a back sheet formed with at least a second ply resulting in a front inner face and a back outer face, the back sheet with at least one die-cut substantially defining a portion conforming to the second section of the front sheet and a receiving area of the first section of the front sheet, the front inner face of the back sheet with adhesive release material patternly disposed thereon, except in a first area, and the front inner face of the back sheet being adhesively attached to the back inner face of the front sheet;
wherein when the portion of the back sheet defined by the die-cut is removed and the foldable flap of the front sheet is folded along the fold line and adhesively bound to a receiving area of the front sheet adjacent to the fold line to substantially abut a remaining portion of the back sheet adhesively attached to the front sheet, the multi-ply form is assembled to have a substantially uniform thickness.

2. The form assembly of claim 1, wherein the back outer surface of the back sheet includes instructional information.

3. The form assembly of claim 1, wherein adhesive material is patternly disposed on the back inner face of the front sheet except on the receiving area in the first section of the back inner face adjacent to the fold line.

4. The form assembly of claim 1, wherein the first section and the second section of the front sheet each include a separate printable image formed thereon.

5. The form assembly of claim 3, wherein the separate printable image formed on the first section comprises at least one of:
one or more graphics;
one or more photographs; and
one or more text characters.

6. The form assembly of claim 3, wherein the separate printable image formed on the second section comprises at least one of a mailing indicia and an addressee information.

7. The form assembly of claim 1, wherein the form is adapted for providing a plurality of post cards on a single sheet of paper, the form being one of:
8.5″×11″ (letter) size paper;
8.5″×14″ (legal) size paper:
8.5″×11″ (letter) size paper;
8.5″×14″ (legal) size paper;
8.27″×11.69″ (A4) size paper;
3.94″×5.83″ (postcard) size paper;
4″×6″ (photo) size paper;
3″×5″ (photo) size paper;
4.13″×9.5″ (envelope) size paper;
8.27″×11.69″ (A4) size paper;
3.94″×5.83″ (postcard) size paper;
4″×6″ (photo) size paper;
3″×5″ (photo) size paper; and
4.13″×9.5″ (envelope) size paper.

8. A form assembly having sections for printing an image on one side thereon by a non-impact printer, the form comprising:
a front sheet formed with a front outer face and a back inner face,
the front outer face of the front sheet including at least a first ply to define a first side of a multi-ply form suitable for mailing and adapted to accept at least one printable image formed thereon, the front sheet including a fold line separating a first section and a second section of the front sheet, wherein a resulting area of the first section is equal to a resulting area of the second section, and the first section defines a first foldable flap and the second section defines a second foldable flap along the fold line; and
the back inner face of the front sheet including an adhesive material patternly disposed thereon;
a back sheet formed with at least a second ply resulting in a front inner face and a back outer face, the back sheet substantially conforming to the front sheet, the front inner face of the back sheet with adhesive release material patternly disposed thereon, and the front inner face of the back sheet being adhesively attached to the back inner face of the front sheet;
wherein when the back sheet is removed and one of the first foldable flap and the second foldable flap of the front sheet is folded and adhesively bound to the back inner face of the front sheet, the multi-ply form is assembled to have a substantially uniform thickness.

9. The form assembly of claim 8, wherein the back outer surface of the back sheet includes instructional information.

10. The form assembly of claim 8, wherein a portion of the back sheet extends beyond an outer edge of the front sheet forming a tab adjacent to the outer edge.

11. The form assembly of claim 8, wherein the first section and the second section of the front sheet each include a separate printable image formed thereon

12. The form assembly of claim 11, wherein the separate printable image formed on the first section comprises at least one of:
one or more graphics;
one or more photographs; and
one or more text characters.

13. The form assembly of claim 11, wherein the separate printable image formed on the second section comprises at least one of a mailing indicia and an addressee information.

14. The form assembly of claim 8, wherein the form is adapted for providing a plurality of post cards on a single sheet of paper, the form being one of:
8.5″×11″ (letter) size paper;
8.5″×14″ (legal) size paper:
8.5″×11″ (letter) size paper;
8.5″×14″ (legal) size paper;
8.27″×11.69″ (A4) size paper;
3.94″×5.83″ (postcard) size paper;
4″×6″ (photo) size paper;
3″×5″ (photo) size paper;
4.13″×9.5″ (envelope) size paper;
8.27″×11.69″ (A4) size paper;
3.94″×5.83″ (postcard) size paper;
4″×6″ (photo) size paper;
3″×5″ (photo) size paper; and
4.13″×9.5″ (envelope) size paper.

15. A form assembly having sections for printing an image on one side thereon by a non-impact printer, the form comprising:
a front sheet formed with a front outer face and a back inner face,
the front outer face of the front sheet including at least a first ply to define a first side of a multi-ply form suitable for mailing and adapted to accept at least one printable image formed thereon, the front sheet including a fold line separating a first section and a second section of the front sheet, wherein a resulting area of the first section is equal to a resulting area of the second section, and the first section defines a first foldable flap and the second section defines a second foldable flap along the fold line; and
the back inner face of the front sheet including an adhesive material patternly disposed thereon;
a back sheet formed with at least a second ply resulting in a front inner face and a back outer face, the back sheet with at least one die-cut substantially defining a portion conforming to the second section of the front sheet, the front inner face of the back sheet with adhesive release material patternly disposed on the portion defined by the die-cut conforming to the second section of the front sheet, and the front inner face of the back sheet being adhesively attached to the back inner face of the front sheet;
wherein when the portion of the back sheet defined by the die-cut is removed and one of the first foldable flap and the second foldable flap of the front sheet is folded and adhesively bound to a remaining portion of the back sheet on the first section, the multi-ply form is assembled to have a substantially uniform thickness

16. The form assembly of claim 15, wherein the back outer surface of the back sheet includes instructional information.

17. The form assembly of claim 15, wherein a portion of the back sheet extends beyond an outer edge of the front sheet forming a tab adjacent to the outer edge.

18. The form assembly of claim 15, wherein the first section and the second section of the front sheet each include a separate printable image formed thereon.

19. The form assembly of claim 18, wherein the separate printable image formed on the first section comprises at least one of:
one or more graphics;
one or more photographs; and
one or more text characters.

20. The form assembly of claim 18, wherein the separate printable image formed on the second section comprises at least one of a mailing indicia and an addressee information.

21. The form assembly of claim 15, wherein the form is adapted for providing a plurality of post cards on a single sheet of paper, the form being one of:
8.5″×11″ (letter) size paper;
8.5″×14″ (legal) size paper:
8.5″×11″ (letter) size paper;
8.5″×14″ (legal) size paper;
8.27″×11.69″ (A4) size paper;
3.94″×5.83″ (postcard) size paper;
4″×6″ (photo) size paper;
3″×5″ (photo) size paper;
4.13″×9.5″ (envelope) size paper;
8.27″×11.69″ (A4) size paper;
3.94″×5.83″ (postcard) size paper;
4″×6″ (photo) size paper;
3″×5″ (photo) size paper; and
4.13″×9.5″ (envelope) size paper.

22. A multi-ply form assembly for duplex printing, the form assembly comprising:
a sandwich assembly of a top ply and a bottom ply, wherein each of the top ply and the bottom ply include an outer face to accept at least one printable image formed thereon in a duplex non-impact printer and a fold line separating the outer face of both the top ply and the outer face of the bottom ply into two substantially equal areas of a first area and a second area;
wherein the top ply includes an inner surface of the second area defined by the fold line with adhesive material disposed thereon and an inner surface of the first area defined by the fold line with adhesive release material disposed thereon;
wherein the bottom ply includes an inner surface of the first area defined by the fold line with adhesive material disposed thereon and an inner surface of the second area defined by the fold line with adhesive release material disposed thereon; and
whereby when the top ply is separated from the bottom ply, each of the top ply and the bottom ply are foldable along the fold line so that the inner surface of the top play with adhesive material disposed thereon is adhesively bound to the inner surface of the top ply with adhesive release disposed thereon, and so that the inner surface of the bottom ply with adhesive release material disposed thereon is adhesively bound to the inner surface of the bottom ply with adhesive material disposed thereon.

23. The form assembly of claim 22, wherein a portion of the top ply extends beyond an outer edge of the bottom ply forming a tab adjacent to the outer edge of the bottom ply and wherein a portion of the bottom ply extends beyond an outer edge of the top ply forming a tab adjacent to the outer edge of the top ply.

24. The form assembly of claim 22, wherein the first section and the second section of each the top ply and bottom ply include a separate printable image formed thereon.

25. The form assembly of claim 24, wherein the separate printable image formed on the first section of the top play and the bottom ply comprises at least one of:
one or more graphics;
one or more photographs; and
one or more text characters.

26. The form assembly of claim 24, wherein the separate printable image formed on the second section of the top play and the bottom ply comprises at least one of a mailing indicia and an addressee information.

27. The form assembly of claim 22, wherein the form is adapted for providing a plurality of post cards on a single sheet of paper, the form being one of:
8.5″×11″ (letter) size paper;
8.5″×14″ (legal) size paper:
8.5″×11″ (letter) size paper;
8.5″×14″ (legal) size paper;
8.27″×11.69″ (A4) size paper;
3.94″×5.83″ (postcard) size paper;
4″×6″ (photo) size paper;
3″×5″ (photo) size paper;
4.13″×9.5″ (envelope) size paper;
8.27″×11.69″ (A4) size paper;
3.94″×5.83″ (postcard) size paper;
4″×6″ (photo) size paper;
3″×5″ (photo) size paper; and
4.13″×9.5″ (envelope) size paper.
